(19) United States
(12) Patent Application Publication
(10) Pub. No.: US 2010/0204031 A1
(43) Pub. Date: Aug. 12, 2010

(54) CORE WINDER WITH FORMING UNIT WITH A TOOTHED BELT

(75) Inventors: Mauro Gelli, Lucca (IT); Mario Gioni Chiocchetti, Lucca (IT); Quirino Ridolfi, Lucca (IT)

Correspondence Address: BREINER & BREINER, L.L.C., P.O. BOX 320160, ALEXANDRIA, VA, 22320-0160, US

(73) Assignee: Fabio Perini S.p.A., Lucca (IT)

(21) Appl. No.: 12/733,544

(22) PCT Filed: Sep. 11, 2008
(86) PCT No.: PCT/IT2008/000585

§ 371 Date: Mar. 8, 2010

(30) Foreign Application Priority Data
Sep. 14, 2007 (IT) FI2007A000207

(51) Int. Cl. B31C 3/00

(52) U.S. Cl. 493/299

(57) ABSTRACT

A core winder is disclosed for forming tubes from at least one helically wound strip of web material, including: a spindle, about which the strip or strips of web material are wound; a forming unit including a belt entrained about at least two pulleys, at least one of which is motorized. The belt forms a loop about the forming spindle. The belt has a front face provided with a toothing cooperating with one of the pulleys, which is also toothed.

### TECHNICAL FIELD

The present invention relates to machines for the production of tubes by means of helical winding of one or more strips of web material, typically cardboard, about a spindle through a forming unit. Machines of this type are usually called “core winders”. They are used for example for the production of tubular cores, in cardboard or similar, for winding rolls of film, paper, tissue paper, or other sheet material.

### STATE OF THE ART

In conventional core winders the forming unit usually comprises a belt entrained about the winding spindle forming a loop, also called “knot”. The loop is inclined with respect to the axis of the spindle by a degree which is approximately equal to the angle of inclination of the turns of web material which form through winding of the strip or strips of web material and which generate the tube. The function of the belt is that of winding the turns of web material about the spindle and of feeding the tube being formed.

Examples of core winders of this type are described in WO-A-9510400; WO-A-9510399; WO-A-2004/106017; WO-A-2007/072531.

Forming units of known type present some drawbacks, due to the use of belts forming the advancing and winding system. In particular:
the “knot” or loop formed by the belt about the tube and the spindle inside the tube must be sufficiently tight to transmit motion and feed to the web material (cardboard or the like) during winding and to the tube itself; if however the knot or loop is too tight, this causes an obstruction to feed due to excessive friction of the tube on the spindle; moreover, belts utilized to date are smooth, i.e. without toothing, and are carried in motion by pulleys, also smooth, which drive the belts in motion through simple friction. To prevent slipping between belt and pulley a certain degree of belt tensioning is necessary, which is acceptable to a certain value, after which it creates problems for feed of the tube being formed, with consequent premature wear and overheating of the forming spindle;
when the machine starts up there is never perfect synchronism between belt and web material, and therefore initial slipping and problems of belt tensioning occur. Loss of time, energy and raw materials are inevitable before achieving a correct operating condition, without slipping between the belt of the forming unit and the web material;
during operation the members indicated above are subject to heating; therefore, before the machine reaches normal operating temperatures, i.e. the ideal operating conditions, continuous adjustments are required, which accentuate the problems of tensioning and transfer.

In current high end core winders, i.e. winders with higher performances and in which a high number of strips are used, it is necessary to have two driving motors for controlling the belt movement, again to reduce transfer and tensioning problems, one mounted on the main pulley and one on a tension pulley about which the belt of the forming unit is entrained. This arrangement is costly.

### SUMMARY OF THE INVENTION

According to one aspect, the invention provides a core winder of the aforesaid type, in which the belt of the forming unit is a toothed belt, equipped with a front surface with a toothing cooperating with a guide pulley, which is also toothed. Preferably, the toothed pulley is a drive pulley. It would also be possible to provide both faces of the belt with toothings, identical to each other or differing if necessary, to cooperate with two pulleys, both toothed. However, in some preferred embodiments the belt presents a smooth back, where smooth is intended as a back without toothings. Preferably, the belt is arranged so that the back is in contact with the strip of web material during winding, i.e. the toothed back is facing the forming spindle about which the strip or strips of web material are wound.

It has been found that the use of a belt of this type considerably reduces at least some of the problems of conventional core winders that typically use smooth belts.

The belt cooperates with two guide pulleys, at least one of which is motorized, and at least one of which (preferably the motorized pulley) is toothed. Preferably, the belt is wound about the spindle so that the surface without toothing, i.e. the back, is facing the forming spindle. In this way the web material fed between the spindle and the loop (knot) formed by the belt is in contact with the smooth back of the belt arranged about the spindle, while the toothing is facing the outside of the loop.

In some embodiments the second pulley is not toothed and is in contact with the back of the belt.

Further advantageous embodiments and features of the invention will be described hereunder with reference to an example of embodiment.

### BRIEF DESCRIPTION OF THE DRAWINGS

The present invention will be better understood by following the description and accompanying drawing, which shows a non-limiting practical embodiment of the invention. More in particular, in the drawing:

FIG. 1 shows a schematic side view of an embodiment of the invention;

FIG. 2 shows a longitudinal section of a portion of the belt, according to the sectional line substantially parallel to the longitudinal extension of the belt;

FIG. 3 shows a cross section according to III-III of FIG. 2; and

FIG. 4 shows a longitudinal section of a portion of belt with double toothing.

### DETAILED DESCRIPTION OF EMBODIMENTS OF THE INVENTION

The core winder shown by way of example in the drawing has a general structure of known type, for example from one or more of the patent publications cited in the introductory part of the present description. Moreover, it most be understood that the constructional details of the core winder can change with respect to those described below, as the present invention can be applied advantageously to a plurality of machines of various type, in which the forming unit comprises a belt that winds forming at least one turn or knot about the spindle.

The core winder, indicated as a whole with 1, comprises a structure 3, on which a spindle 5 is mounted by means of a support 8. The axis of the spindle is indicated with A-A. This spindle can be fixed, or can be mounted idle about its axis, or yet again can present a fixed part and an idly supported rotating part.

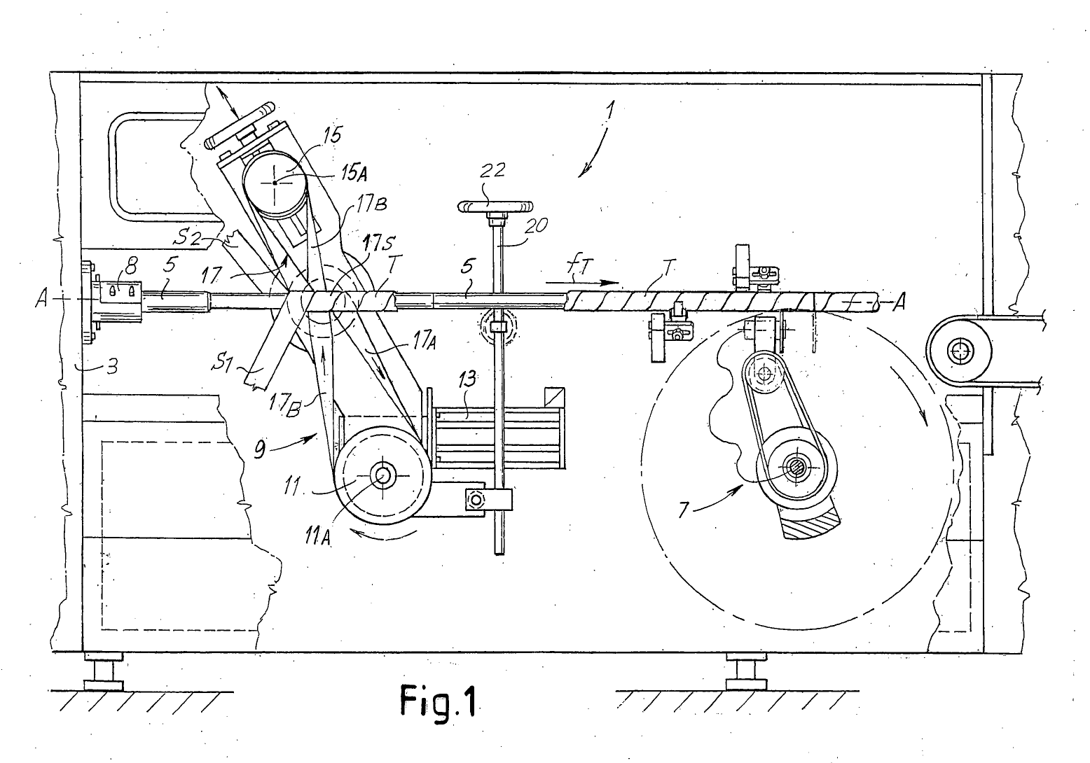

A cutting unit 7, which can have any structure, is associated with the spindle 5. FIG. 1 shows a cutting device or unit of the type described in WO-A-2004/106017, but other cutting units can be used. This cutting unit 7 provides for cutting into individual portions of a tube T formed continuously about the spindle 5 by means of a forming unit 9, described below.

In the embodiment shown, the forming unit 9 comprises a first toothed pulley 11, rotating about an axis 11A and motorized by means of a motor 13. The forming unit 9 also comprises a second pulley 15, which, unlike the first pulley 11, is smooth. In some preferred embodiments the pulley 15 is mounted idle about its own axis 15A.

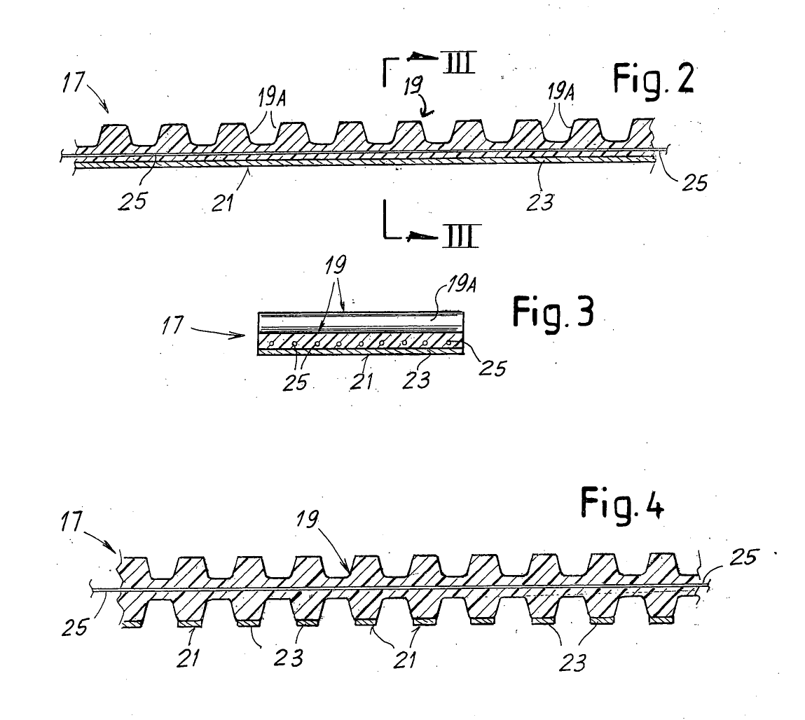

A toothed belt 17 is fed about the two pulleys 11 and 15. As shown in FIG. 2, the toothed belt 17 has a front face 19 provided with a toothing 19A, and a rear face or back 21 which is substantially smooth, i.e. without toothing.

The belt 17 is arranged about the pulleys 11 and 15 so as to form a first branch 17A, which winds forming a loop or “knot” about the spindle 5, and a second straight branch 17B. The belt is arranged so that the front face 19A is in contact with the motorized toothed pulley 11 and so that the smooth back 19B is in contact with the idle pulley 15 and with the strip or strips of web material S1, S2 which are wound about the spindle 5 to form the tube T.

A glue, for example, has been applied to at least one of the strips S1, S2 to make the strips and/or the turns forming the tube T mutually adhere. The strips S1, S2 (or also more strips or a single strip) are fed between the spindle 5 and the knot or loop formed by the branch 17A of the belt 17 about said spindle. The loop formed by the belt 17 has approximately the same inclination as the turns formed by the strips S1, S2 about the spindle 5. In some embodiments this inclination is adjustable by means of a handwheel 22 and a threaded bar 20, with which it is possible to adjust the inclination of the forming unit 9.

For improved operation of the core winder, and for greater duration of the belt, the back 21 thereof can be formed with a covering layer 23 made of material with high resistance to heat and to mechanical stresses. Preferably, the surface of the back 21 of the belt 17 also presents a high friction coefficient to facilitate the gripping and drawing effect on the web material forming the tube T.

In some embodiments, the belt 17 can be reinforced with strands 25 (see FIG. 3). To facilitate forming of the knot or loop 17S (FIG. 1), the strands 25 can be made in non-metallic material, such as Kevlar®, which provides sufficient strength and dimensional stability, without damaging elongations of the belt, but which at the same time do not stiffen it excessively, facilitating forming of the turn 21 also about a spindle 5 of small diameter.

In an alternative embodiment, the belt 17 has opposed double toothing, i.e. both the front face 19 and the rear face 21 have a toothing, identical to or differing in shape from the toothing 19A present on the front face 19. FIG. 4 shows in a longitudinal section a portion of belt designed in this manner. In this embodiment the two toothings on the back and on the front face 21, 19 differ slightly from each other, but it would also be possible for the two toothings to be the same. Also in this case the back 21 can present a coating 23 made of a material with high resistance to heat and to mechanical stresses, at least on the upper face of the projections forming the toothing of the belt and which come into contact with the web material forming the tube T. In this embodiment, the second pulley 15 can again be smooth or, advantageously, with negative toothing with respect to the toothing of the back 21 of the belt 17.

It is understood that the drawing only shows an example provided by way of a practical demonstration of the invention, which can vary in forms and arrangement without however departing from the scope of the concept underlying the invention. Any reference numbers in the appended claims are provided to facilitate reading of the claims with reference to the description and to the drawing, and do not limit the scope of protection represented by the claims.

1-11. (canceled)

12. A core winder for producing tubes from at least one strip of web material helically wound, comprising: a spindle about which said at least one strip of web material is wound; a forming unit including a belt entrained about at least two pulleys, at least one of said at least two pulleys being motorized, said belt forming a loop about the spindle; wherein said belt has a front side provided with first toothing; and wherein at least a first pulley of said at least two pulleys includes second toothing which cooperates with the first toothing of said belt.

13. The core winder as claimed in claim 12, wherein said belt has a back side without toothing; and the belt is wound about the spindle so that the back side is facing the spindle.

14. The core winder as claimed in claim 12, wherein said first pulley including said second toothing is a driving pulley.

15. The core winder as claimed in claim 13, wherein said first pulley including said second toothing is a driving pulley.

16. The core winder as claimed in claim 13, wherein a second pulley of said at least two pulleys is smooth and the back side of the belt is in contact with said second pulley.

17. The core winder as claimed in claim 12, wherein a back side of the belt includes a third toothing.

18. The core winder as claimed in claim 17, wherein the third toothing of the back side is same as the first toothing of the front side.

19. The core winder as claimed in claim 17, wherein the third toothing of the back side is different from the first toothing of the front side.

20. The core winder as claimed in claim 17, wherein the third toothing of the belt is in contact with a second pulley of said at least two pulleys.

21. The core winder as claimed in claim 18, wherein the third toothing of the belt is in contact with a second pulley of said at least two pulleys.

22. The core winder as claimed in claim 13, wherein the back side of the belt is covered in a material having a high friction coefficient.

23. The core winder as claimed in claim 14, wherein a back side of the belt is covered in a material having a high friction coefficient.

24. The core winder as claimed in claim 15, wherein the back side of the belt is covered in a material having a high friction coefficient.

25. The core winder as claimed in claim 12, wherein Kevlar® strands are provided inside said belt.

26. The core winder as claimed in claim 12, wherein said belt is fed solely about said at least two pulleys and only one of said at least two pulleys is motorized.
